(19) United States
(12) Patent Application Publication
(10) Pub. No.: US 2014/0096355 A1
(43) Pub. Date: Apr. 10, 2014

(54) FLUID COUPLER

(71) Applicants: Dirk Jacobus Luyendijk, Heeswijk-Dinther (NL); Eduard Cornelis Maria Henricus Christianus Van Amelsfoort, Tilburg (NL); Holger Jongebloed, Wilheimshaven (DE)

(72) Inventors: Dirk Jacobus Luyendijk, Heeswijk-Dinther (NL); Eduard Cornelis Maria Henricus Christianus Van Amelsfoort, Tilburg (NL); Holger Jongebloed, Wilheimshaven (DE)

(21) Appl. No.: 13/989,767

(22) PCT Filed: Dec. 13, 2011
(86) PCT No.: PCT/EP11/72548

§ 371 Date: Dec. 24, 2013

(30) Foreign Application Priority Data
Dec. 14, 2010 (EP) 10194960.0

(51) Int. Cl. F16L 21/00; F16L 17/06

(52) U.S. Cl. CPC F16L 21/00; F16L 17/06
USPC 29/428; 285/61

(57) ABSTRACT

A fluid coupler (10) for aligned engagement of fluid connectors (40,76), comprising a support member (12); a floating first connector member (14) housed in the support member (12) and engageable to a second connector member (74); a piston member (16) axially slidable in the support member (12) and actuatable to push the first connector member (14) at pressurisation of a fluid circuit.

### TECHNICAL FIELD

This disclosure relates to a device and a method for alignment of male and female fluidconnectors for engagement of these components, in particular for an engagement which allows for a displacement between the male and female fluidconnectors.

### BACKGROUND

Conventional male and female fluidconnectors may be used to sealingly join pressurised fluid lines. When engaged, the corresponding fluidconnectors may automatically enable the fluid and/or fluid pressure to be transmitted, through a mutual passageway formed at engagement. These corresponding fluidconnectors may reliably maintain high fluid pressure after repeated engagement and disengagement operations.

The corresponding fluidconnectors may need to be suitably aligned before their engagement. Alignment of the fluidconnectors may be necessary in order to establish a reliable and leak free connection. Proper alignment of the corresponding connectors prior to engagement may also increase the service life of the components.

A fluidconnector may have to be aligned with high accuracy to avoid excessive wear of the internal components which may eventually result in a leaking connection. When fluidconnectors are coupled in an automated environment, the final alignment of the fluidconnectors during the engagement process may be critical since the connecting force may often be much higher compared to a manual connect system. Hence, any misalignment in combination with the high connecting force may cause a deterioration of the fluidconnectors.

A cause for fluidconnector misalignment may be changes in temperature. A significant temperature difference may be present between a fluidconnector and a corresponding fluid connector. As a result of thermal material expansion, the fluidconnectors may no longer be aligned properly.

A series of fluidconnectors may be mounted in a mounting plate to ensure simultaneous engagement of the fluidconnectors for different hydraulic functions. Such a mounting plate may be used on either one or on both of a coupling and plug side of the fluidconnector configuration. As a result of stacked-up tolerances, the positions of corresponding fluidconnectors may be slightly misaligned. This misalignment may not be avoided without very accurate machining of the fluidconnectors, at very high cost.

The foregoing examples of misalignment may not be compensated until the fluidconnectors start to engage.

U.S. Pat. No. 4,709,726 discloses a hydraulic coupler for interconnecting subsea fluid lines and may have a metallic seal between the male and female portions. The C-shaped metallic seal may be radially compressed between the female and male coupler bodies, so that axial movement between these bodies does not effect sealing effectiveness. A floating retainer ring may be housed within the female body by a fixed retainer ring which may allow for radial misalignment between the coupling halves. The floating retainer ring may become centered with respect to the male coupling body. A metallic face seal may provide sealing engagement between the floating and fixed retainers. Both axial and radial deviation between the coupling bodies may be permissible, so that the coupling may reliably seal fluid after repeated coupling and uncoupling operations.

The present disclosure is directed, at least in part, to improving or overcoming one or more aspects of the prior art couplers.

### BRIEF SUMMARY OF THE INVENTION

In a first aspect, the present disclosure describes a fluid coupler for aligned engagement of fluid connectors, comprising a support member; a floating first connector member housed in the support member and engageable to a second connector member; a piston member axially slidable in the support member at pressurisation of a circuit.

In a second aspect, the present disclosure describes a method of aligned engagement of fluid connectors, comprising the steps of housing a floating first connector member in a support member; engaging the first connector member to a second connector member; pressurizing a fluid circuit to axially slide a piston member in the support member.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is a cross-sectional view of a fluid coupler according to an embodiment of the present disclosure;

FIG. 2 is a cross-sectional view of a fluid coupler of FIG. 1 and a corresponding fluid coupler prior to engagement according to an embodiment of the present disclosure;

FIG. 3 is an isometric view of a fluid coupler of FIG. 1 according to an embodiment of the present disclosure;

FIG. 4 is a bottom view of the corresponding coupler of FIG. 2 according to an embodiment of the present disclosure.;

FIGS. 5a-5c are sectional views of a guiding pin and a bushing in the fluid coupler and the corresponding coupler at various stages of engagement according to an embodiment of the present disclosure.

### DETAILED DESCRIPTION

This disclosure generally relates to the alignment of male and female fluidconnectors, supported in respective couplers, for engagement of these components and in particular an engagement which compensates for a misalignment between the male and female fluidconnectors.

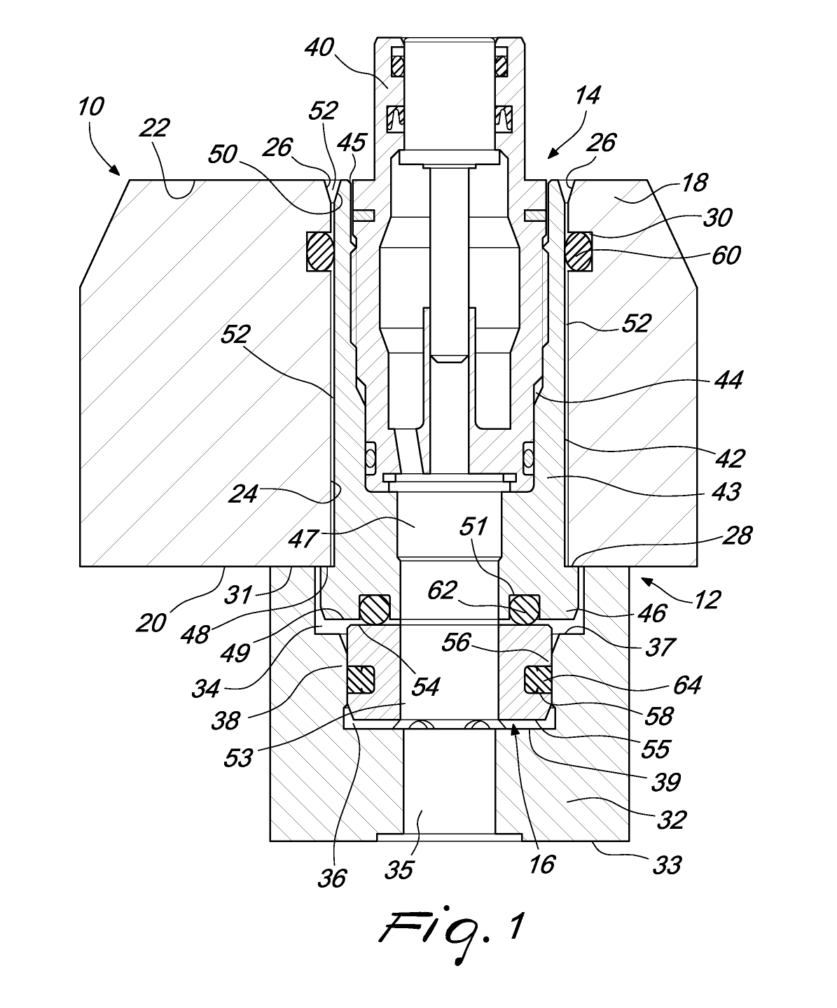

FIG. 1 illustrates a fluid coupler 10 which may comprise a support member 12, a first connector member 14 and a piston member 16. The first connector member 14 may be housed in the support member 12. The piston member 16 may be axially slidable in the support member 12.

In an embodiment, the support member 12 may comprise a cartridge 18 and a mounting plate 32. The cartridge 18 and the mounting plate 32 may be mutually connected. The cartridge 18 may be rigidly mounted to the mounting plate 32.

The cartridge 18 may have a configuration for engaging the mounting plate 32 and for accommodating the first connector member 14. The cartridge 18 may be formed as a block and may have a first cartridge side 20 and a second cartridge side 22. The first cartridge side 20 and the second cartridge side 22 may be parallel. The first cartridge side 20 may be in contact with a surface of the mounting plate 32 when cartridge 18 and mounting plate 32 may be mutually connected. The second cartridge side 22 may engage to a surface of a corresponding mounting plate of a corresponding coupler.

The cartridge 18 may include a channel 24. The channel 24 may be annular and may extend through cartridge 18. The channel 24 may have openings on the first cartridge side 20 and the second cartridge side 22. The longitudinal axis of the channel 24 may be perpendicular to the first cartridge side 20 and the second cartridge side 22. In the fluid coupler 10, the first connector member 14 may be substantially or completely accommodated within the channel 24.

The edge of the opening of channel 24 at the second cartridge side 22 may be inclined away from the longitudinal axis of the channel 24 to form an inclined edge 26. The inclined edge 26 may encircle the opening of the channel 24 at the second cartridge side 22.

In an embodiment, the cartridge 18 may comprise a groove 30. The groove 30 may be cut into the cartridge 18. The groove 30 may be positioned at channel 24 such that a side opens to channel 24. The groove 30 may be concentric with channel 24 and may be positioned at any point along the channel 24. In an embodiment, the groove 30 may be positioned adjacent the opening of the channel 24 at the second cartridge side 22. In an embodiment, the groove 30 may be positioned adjacent the inclined edge 26.

In an embodiment, the cartridge 18 may comprise a plurality of grooves 30 at channel 24 such that each groove has a side that opens to channel 24.

The opening of the channel 24 at first cartridge side 20 may have an abutment edge 28.

The abutment edge 28 may be configured to engage the first connector member 14. The abutment edge 28 may be orthogonal to the longitudinal axis of the channel 24. In an embodiment the abutment edge 28 may encircle the opening of channel 24 at first cartridge side 20. In an alternative embodiment, abutment edge 28 may be disposed from the opening of channel 24 and within the channel 24.

The mounting plate 32 may be configured for engaging the cartridge 18 and for accommodating the first connector member 14. The mounting plate 32 may be formed as a block and may have a first plate side 31 and a second plate side 33. The first plate side 31 and the second plate side 33 may be parallel. In the fluid coupler 10, the first plate side 31 may contact the first cartridge side 20 of the cartridge 18.

The mounting plate 32 may include a through cavity which may be formed by an abutment chamber 34, a fluid chamber 36 and a fluid passage 35. The cavity may have openings on the first plate side 31 and the second plate side 33. The abutment chamber 34 may have an opening at the first plate side 31. The fluid passage 35 may have an opening at the second plate side 33. The opening of the abutment chamber 34, at the first plate side 31, may be greater than the opening of the fluid passage 35, at the second plate side 33.

In an embodiment, each of the abutment chamber 34, the fluid chamber 36 and the fluid passage 35 may have an annular geometry. The diameter of the abutment chamber 34 may be greater than the diameter of the fluid chamber 36 and diameter of the fluid passage 35. The diameter of the fluid chamber 36 may be greater than diameter of the fluid passage 35.

The longitudinal axis of the cavity may be perpendicular to the first plate side 31 and the second plate side 33. The longitudinal axis of the cavity may be continuous with the longitudinal axis of the channel 24 when the cartridge 18 is mounted to the mounting plate 32 to form a common longitudinal axis in the support member 12.

In the assembled support member 12, the abutment edge 28 may extend over the opening of the abutment chamber 34. The abutment edge 28 may be substantially perpendicular to the enclosing wall of the abutment chamber 34.

An abutment ledge 37 may extend from the enclosing wall of the abutment chamber 34, substantially transverse to the longitudinal axis of the cavity of the mounting plate 32, into the cavity of the mounting plate 32. In the assembled support member 12, abutment ledge 37 may be opposite and substantially parallel to the abutment edge 28.

The enclosing wall of the fluid chamber 36 may extend further into the cavity of the mounting plate 32 than the enclosing wall of the abutment chamber 34. A piston guide 38 may be formed on the enclosing wall of the fluid chamber 36. The piston guide 38 may be a protrusion into the fluid chamber 36. The piston guide 38 may be a convex protrusion with a flattened apex.

In an embodiment, the piston guide 38 may be formed as a continuous ring on the enclosing wall of the fluid chamber 36 and may have a raised central portion and sloping sides inclined away from the longitudinal axis of the cavity in the mounting plate 32. The apex of the central raised portion of the piston guide 38 may be flattened.

A fluid chamber ledge 39 may extend from the enclosing wall of the fluid chamber 36, substantially transverse to the longitudinal axis of the cavity in the mounting plate 32, into the cavity of the mounting plate 32. The fluid chamber ledge 39 may be substantially parallel to the abutment ledge 37. The enclosing wall of the fluid passage 35 may extend further into the cavity in the mounting plate 32 than the enclosing wall of the fluid chamber 36.

In the assembled support member 12, the abutment chamber 34 and channel 24 may be contiguous to mutually house the first connector member 14.

The first connector member 14 may comprise a fluidconnector 40 and a fluidconnector sleeve 42. The fluidconnector sleeve 42 may be configured to receive fluidconnector 40.

The fluidconnector sleeve 42 may comprise a body portion 43 having a central axis. The body portion 43 may include a compartment 44 which may be configured to receive and rigidly hold fluidconnector 40.

The compartment 44 may have an inlet 45 at an end. The fluidconnector 40 may be inserted into the compartment 44 and extracted from the compartment through the inlet 45. The fluidconnector 40 may be assembled into fluid coupler 10 and disassembled from the fluid coupler 10 without removing the fluidconnector sleeve 42. The servicing and/or replacement of the fluidconnector 40 may be performed through the extraction of only the fluidconnector 40. The compartment 44 may have a treaded portion to rigidly mount the fluidconnector 40.

The body portion 43 of fluidconnector sleeve 42 may include a conduit 47 extending from the compartment 44 and along the direction of the central axis of the body portion 43. The conduit 47 may extend to the end of the body portion 43 opposite the inlet 45. The conduit 47 may have an opening at the end of the body portion 43 opposite the inlet 45. The compartment 44 and the conduit 47 may form a continuos passage through the body portion 43. In the first connector member 14, having the fluidconnector 40 inserted into the fluidconnector sleeve 42, a fluid channel in the fluidconnector 40 may be contiguous with the conduit 47 to form a continuos fluid passage through the first connector member 14.

The fluidconnector sleeve 42 may comprise a flange portion 46 at the end opposite inlet 45. The flange portion 46 may extend in a direction substantially transverse to the central axis of the body portion 43 away from the conduit 47. In an embodiment, the flange portion 46 may be formed as a continuous ring around the body portion 43. In an alternative embodiment, the flange portion 46 may be formed as a discontinuous ring around the body portion 43.

The flange portion 46 may have an abutment seat 48 formed at a side thereof. The abutment seat 48 may be configured to engage the cartridge 18.

The body portion 43 and flange portion 46 may have a thrust surface 49 at the end opposite inlet 45. The thrust surface 49 may be opposite and parallel to the abutment seat 48. The thrust surface 49 may be transverse to the central axis of the body portion 43. The conduit 47 of body portion 43 may have an opening at thrust surface 49. The inner perimeter of the thrust surface 49 may delimit the opening of conduit 47. The thrust surface 49 may be configured to engage a surface of the piston member 16.

The body portion 43 may have a bevelled edge 50 at the end provided with the inlet 45. The bevelled edge 50 may be inclined toward the central axis of the body portion 43. The bevelled edge 50 may form a ring around the body portion 43 adjacent the inlet 45.

In an embodiment, the body portion 43 may comprise a slot 51. The slot 51 may be cut into the thrust surface 49 of body portion 43. The slot 51 may be positioned at thrust surface 49 such that a side has an opening at thrust surface 49. The slot 51 may be concentric with conduit 47 and may be disposed at any position along the thrust surface 49 which may engage piston member 16. In an embodiment, the slot 51 may be positioned adjacent the inner perimeter of the thrust surface 49 which may delimit the opening of conduit 47.

In an embodiment, the fluidconnector 40 and the fluidconnector sleeve 42 may be integral so that the first connector member 14 may be a monolithic structure. The monolithic first connector member 14 may include the body portion 43.

In the fluid coupler 10, the first connector member 14 may not be mounted or joined to the support member 12. The first connector member 14 may be free to move within the channel 24 and the abutment chamber 34.

The fluid coupler 10 may comprise an alignment gap 52 between the support member 12 and the first connector member 14 for floating movement of the first connector member 14. The alignment gap 52 may be formed by suitably configuring the body portion 43, flange 46, cartridge 18, mounting plate 32, channel 24 or the abutment chamber 34 or any combination thereof. The dimension and/or geometry of the body portion 43, flange 46, cartridge 18, mounting plate 32, channel 24 or the abutment chamber 34 may be suitably adapted to provide for the alignment gap 52.

The alignment gap 52 may enable a radial movement of the first connector member 14 relative to the support member 12. First connector member 14 may be radially displaced in a direction transverse to the longitudinal axis of the channel 24. The magnitude of displacement of first connector member 14 may be dependent on the alignment gap 52. During a radial displacement of first connector member 14 the angle between the central axis of the body portion 43 and the longitudinal axis of the channel 24 may remain constant.

The alignment gap 52 may enable a pivotal movement of the first connector member 14 relative to the support member 12. First connector member 14 may be pivotably displaced at an angle relative to the longitudinal axis of the channel 24. The magnitude of displacement of first connector member 14 may be dependent on the alignment gap 52. During a pivotal displacement of first connector member 14 the angle between the central axis of the body portion 43 and the longitudinal axis of the channel 24 may vary.

The alignment gap 52 may enable a combined pivotal and radial movement of the first connector member 14 relative to the support member 12. First connector member 14 may be displaced at an angle relative to the longitudinal axis of the channel 24 and may be displaced in a direction transverse to the longitudinal axis of the channel 24. The magnitude of a combined pivotal and radial displacement of first connector member 14 may be dependent on the alignment gap 52. During a combined pivotal and radial displacement of first connector member 14 the angle between the central axis of the body portion 43 and the longitudinal axis of the channel 24 may vary.

The body portion 43 of the fluidconnector sleeve 42 may be partly accommodated in the channel 24 and partly in the abutment chamber 34 of the mounting plate 32. The movement of the body portion 43 in the support member 12 may be restricted by the enclosing wall of the channel 24.

The flange portion 46 may be accommodated in the abutment chamber 34. The movement of the flange portion 46 in the support member 12 may be restricted by the abutment edge 28 of the cartridge 18 and the enclosing wall of the abutment chamber 34 and the abutment ledge 37.

In the fluid coupler 10, the bevelled edge 50 of the body portion 43 and the inclined edge 26 of the channel 24 may have an angular spacing of about 20°-30°.

The piston member 16 may comprise a piston conduit 53. The piston conduit 53 may form a through fluid passage and may be centrally positioned in the piston member 16. The piston conduit 53 may have an opening at a piston thrust surface 54 and an opening at a piston surface 55. The piston thrust surface 54 and the piston surface 55 may be mutually opposite and parallel. Between and substantially perpendicular to the piston thrust surface 54 and the piston surface 55 may be a piston guide 56.

The piston guide 56 may have a piston inclined edge 57 adjacent to the piston surface 55. The piston inclined edge 57 may be formed as a ring around the piston member 16.

In an embodiment, the piston guide 56 may have a further inclined edge adjacent to the piston thrust surface 54. This further inclined edge may be formed as a ring around the piston member 16.

In an embodiment, the piston guide 56 may comprise a piston groove 58. The piston groove 58 may be cut into the piston guide 56. The piston groove 58 may be positioned at the piston guide 56 such that a side has an opening piston guide 56. The piston groove 58 may be disposed at any position along the piston guide 56 which may engage guide 38.

In the fluid coupler 10, the piston member 16 may be mounted in the support member 12, within the enclosing wall of the fluid chamber 36 of the mounting plate 32. The piston member 16 may be slidably engaged to the enclosing wall of the fluid chamber 36 and may move in an axial direction parallel to the longitudinal axis of the cavity in the mounting plate 32. The guide 38 may engage to the piston guide 56.

The guide 38 and the piston guide 56 may be configured to enable the piston member 16 to axially slide in the mounting plate 32. The dimension and/or geometry of the guide 38 and the piston guide 56 may be suitably adapted to allow piston member 16 to axially slide in the mounting plate 32.

In the fluid coupler 10, the piston member 16 may be positioned between the thrust surface 49 of the first fluidconnector member 14 and the fluid chamber ledge 39. The axial movement of the piston member 16 may be restricted. In a direction, the piston member 16 may be restricted by the fluid chamber ledge 39 contacting the piston surface 55. In the opposite direction, the piston member 16 may be restricted by piston thrust surface 54 contacting the thrust surface 49 of the first fluid connector 14 when the abutment seat 48 abuts the abutment edge 28 of the cartridge 18.

In an embodiment, the piston member 16 may also be pivotable relative to the mounting plate 32. The guide 38 and the piston guide 56 may be configured to enable the piston member 16 to pivot in the mounting plate 32. The dimension and/or geometry of the guide 38 and the piston guide 56 may be suitably adapted to allow piston member 16 to pivot in the mounting plate 32.

In the fluid coupler 10, the piston member 16 may be actuatable under fluid pressure to slide axially in the guide 38 toward first connector member 14. The piston member 16 may push the first connector member 14 into abutting engagement with the cartridge 18 of the support member 12.

The piston member 16 may eliminate the need to connect a fluid hose directly to the first connector member 14 thereby eliminating any reaction forces that may be introduced by the fluid hoses.

In the fluid coupler 10, the fluid passage 35, conduit 47 and the piston conduit 53 may have the same diameters.

The fluid coupler 10 may comprise a compressible element 60 positioned in the groove 30. The compressible element 60 may be positioned between the cartridge 18 of the support member 12 and the body portion 43 of the first connector member 14. The compressible element 60 may be a flexible ring. The compressible element 60 may be made from a compressive material such as nitrile rubber or polyurethane.

In an embodiment, the fluid coupler 10 may comprise a plurality of compressible elements 60 positioned in a plurality of grooves 30.

The compressible element 60 may return the first connector member 14 to a neutral position after disengagement from a second connector member. The compressible element 60 may return the first connector member 14 to the neutral position after disengagement of the fluidconnector 40 and a corresponding fluidconnector. The neutral position of first connector member 14 may be the position prior to engagement of the fluidconnector 40 and a corresponding fluidconnector.

The fluid coupler 10 may comprise a thrust seal 62 positioned in the slot 51. The compression of the thrust seal 62 may be positioned between the body portion 43 of the first connector member 14 and the piston thrust surface 54. A movement of piston thrust surface 54 against the thrust surface 49 of the first connector member 14 may compress the thrust seal 62. The thrust seal 62 may ensure that a fluid does not leak from between the piston member 16 and the first connector member 14 into the abutment chamber 34. In an embodiment, the thrust seal 62 may be an O-ring.

The fluid coupler 10 may comprise a piston seal 64 positioned in the piston groove 58. The piston seal 64 may be positioned between the guide 38 and the piston member 16. The piston seal 64 may ensure that a fluid does not leak from between the piston member 16 and the guide 38 into the abutment chamber 34.

In an embodiment, the piston seal 64 may also be configured to allow a pivotal movement of the piston member 16.

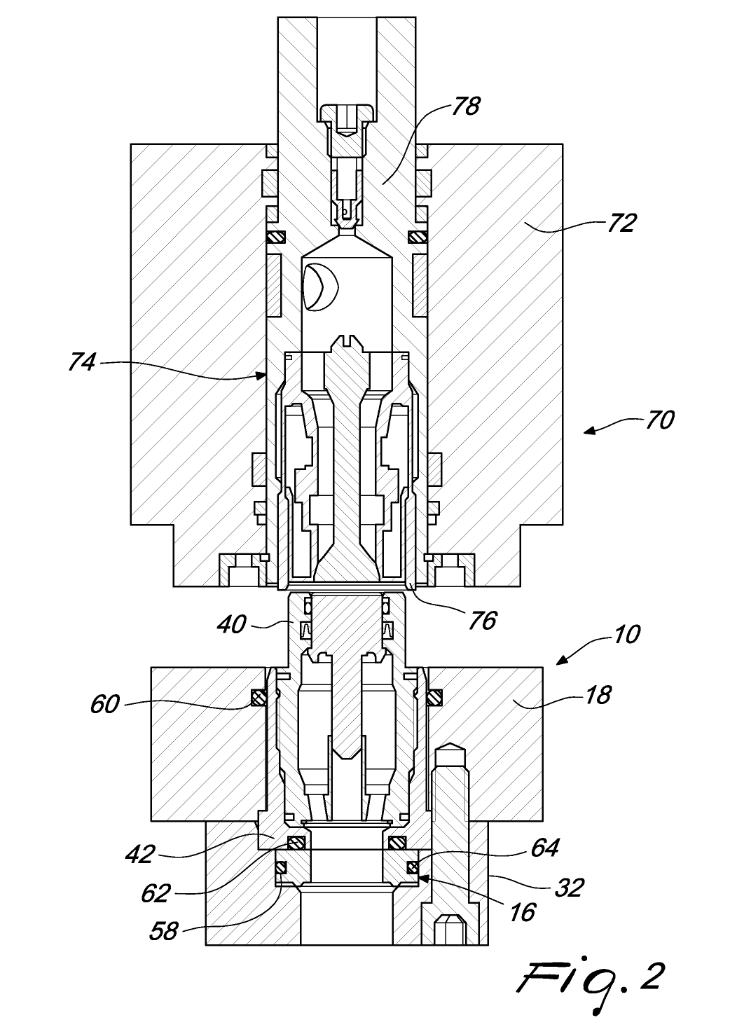

FIG. 2 illustrates a fluid coupler 10 aligned to a corresponding fluid coupler 70. The corresponding fluid coupler 70 may comprise a corresponding cartridge 72 and a second fluidconnector member 74. The second fluidconnector member 74 may comprise a corresponding fluidconnector 76 and a sliding sleeve 78.

Fluidconnector 40 may be suitably formed to engage with the corresponding fluidconnector 76. The fluidconnector 40 and the corresponding fluidconnector 76 may be configured for detachable reciprocal engagement. The engagement surfaces of the fluidconnector 40 and corresponding fluidconnector 76 may be formed to allow efficient engagement and disengagement in a direction substantially parallel to the longitudinal axes of the fluidconnector 40 and corresponding fluidconnector 76. In an embodiment, the fluidconnector 40 may be a male fluidconnector while corresponding fluidconnector 76 may be a female fluidconnector. In an alternative embodiment, the fluidconnector 40 may be a female fluidconnector while corresponding fluidconnector 76 may be a male fluidconnector.

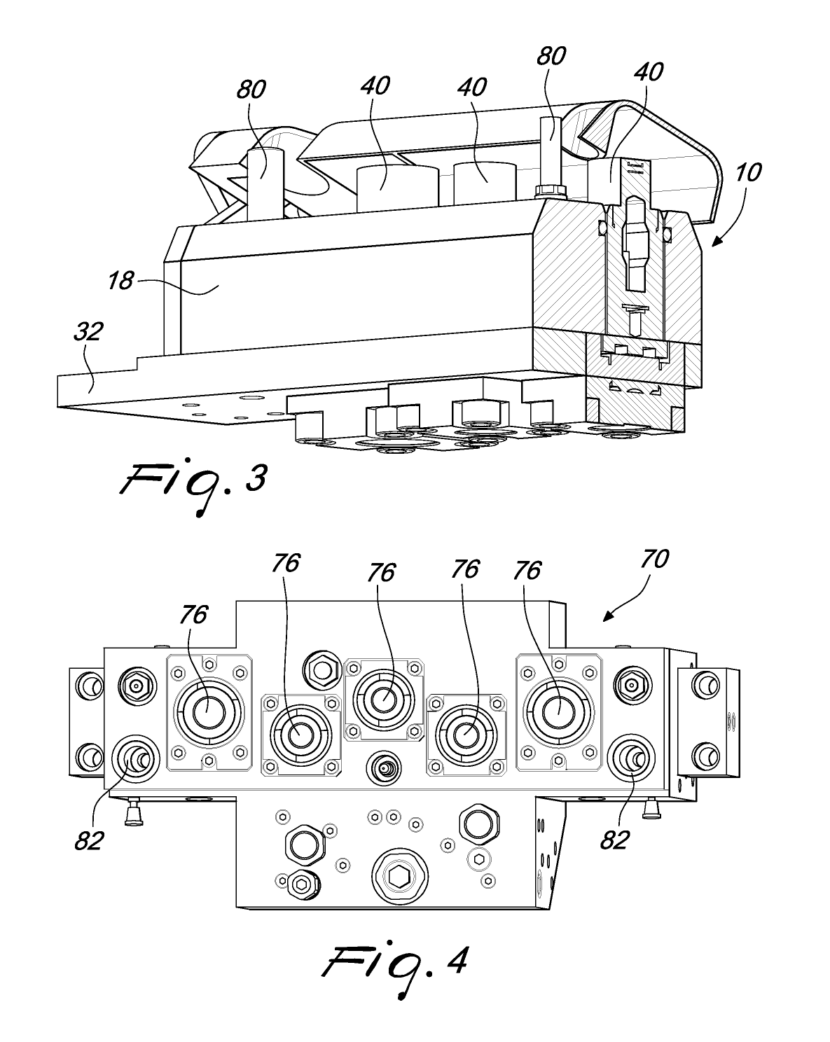

FIG. 3 illustrates a fluid coupler 10 which may comprise a support member 12, a plurality of first connector members 14 and a plurality of piston members 16. The fluid coupler 10 may further comprise guiding pins 80. In an embodiment, the fluid coupler 10 may be mounted in a mounting bracket for engagement to corresponding fluid coupler 70.

FIG. 4 illustrates the corresponding coupler 70 which may have a corresponding cartridge 72 and a plurality of second fluidconnector members 74 and a plurality of corresponding fluidconnectors 76. The corresponding fluid coupler 70 may further comprise guiding bushings 82. In an embodiment, the corresponding fluid coupler 70 may be mounted in a quick coupler for engagement to the fluid coupler 10.

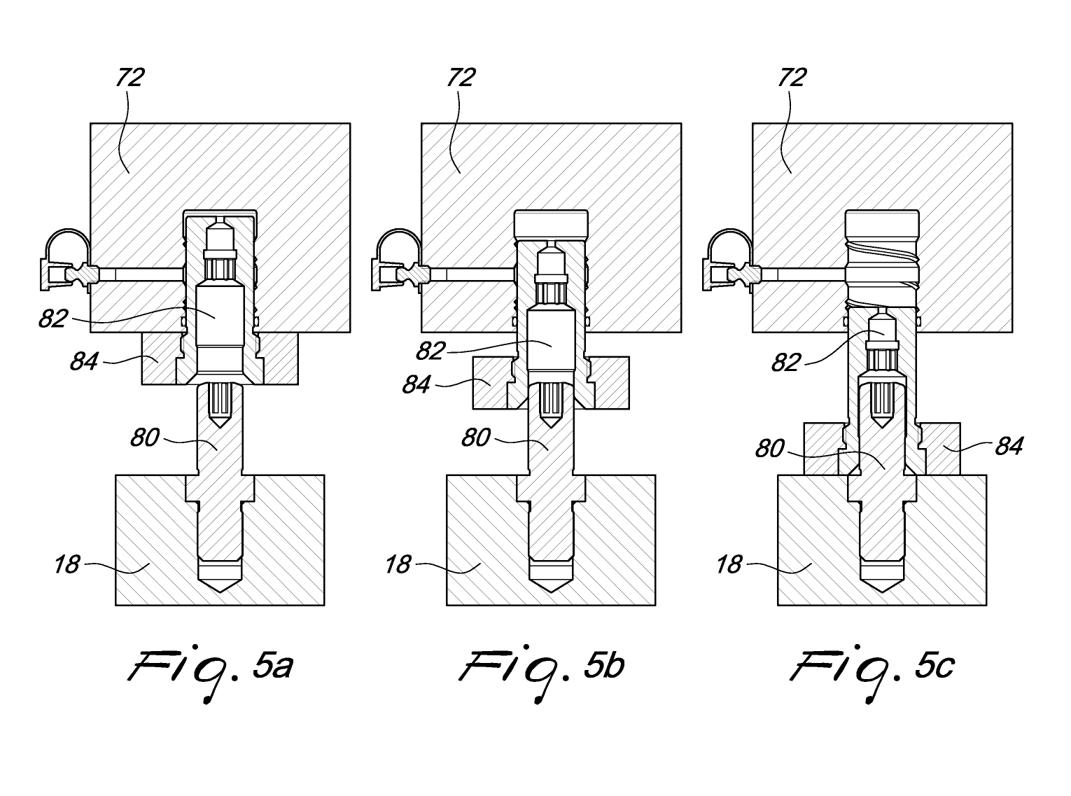

FIGS. 5a-5c illustrate the guiding pin 80 of a fluid coupler 10 and the guiding bushing 82 of the corresponding coupler 70 at various stages of engagement. In FIG. 5a, the guiding pin 80 and guiding bushing 82 may be aligned when the fluid coupler 10 is mounted in a mounting bracket and the corresponding fluid coupler 70 is mounted in a quick coupler. In FIG. 5b, the guiding pin 80 and guiding bushing 82 may initiate engagement. In FIG. 5c, the guiding pin 80 and guiding bushing 82 may be engaged. In an embodiment, the first connector member 14 and the second connector member 74 may initiate engagement after the guiding pin 80 and guiding bushing 82 may be engaged.

In an embodiment, the fluid coupler 10 may be mounted in a mounting bracket and the corresponding fluid coupler 70 may be mounted in a quick coupler for a reciprocal engagement. There may be a rough alignment between the quickcoupler and mounting bracket. The quickcoupler and mounting bracket may be locked after being positioned correctly by means of a locking member.

After the connection between quickcoupler and mounting bracket is locked, the corresponding mounting plate 84 with the second connector members 74 may move towards the first connector members 14. The guiding pins 80 on the fluid coupler 10 may align with the guiding bushing 82 in the corresponding coupler 70 and may initiate engagement. After engagement of the guiding pins 80 and the guiding bushing 82 the engagement of the first and second connector members 14, 74 may commence.

A method of aligned engagement of a fluidconnector 40 and a corresponding fluidconnector 76, according to the present disclosure, may involve providing a floating first connector member 14 housed in a support member 12, engaging the first connector member 14 to a second connector member 74, and pressurising a fluid circuit to axially slide a piston member 16 in the support member 12.

During engagement of the first connector member 14 to the second connector member 74, the first connector member 14 may be radially and/or pivotably displaced. The radial and/or pivotal displacement of the first connector member 14 may allow for a smooth and efficient engagement of the first connector member 14 to the second connector member 74.

In an embodiment, during engagement of the first connector member 14 to the second connector member 74, the piston member 16 may also be pivotally displaced. The piston member 16 may be pivotally displaced in unison with a pivotal displacement of the first connector member 14. The pivotal displacement of the piston member 16 may allow for the thrust surface 49 of the first connector member 14 to remain in parallel with the piston thrust surface 54.

During aligned engagement of the first connector member 14 to the second connector member 74 the fluid coupler is not under fluid pressure. After the engagement of the first connector member 14 to the second connector member 74 the fluid circuit is pressurised. The pressurised fluid may flow into the fluid chamber 36 through the fluid passage 35.

The flow of pressurised fluid pushes the piston member 16 to slide axially in the guide 38. The piston member 16 may be forced by the pressurised fluid into pushing contact with the first connector member 14. The piston member 16 pushing on the first connector member 14 may compress a thrust seal 62 disposed between the piston member 16 and the first connector member 14. The first connector member 14 may be pushed into abutting engagement with the cartridge 18 of the support member 12. In this abutting engagement, the first connector member 14 may not be radially and/or pivotably displaced. The first connector member 14 may be stably held against the cartridge 18 through the force of the pressurised fluid.

Prior to disengagement, the fluid circuit is depressurised which may allow the first connector member 14 to be radially and/or pivotably displaced. Subsequently, the first connector member 14 and the second connector member 74 may be disengaged. The compressible element 60 may return the first connector member 14 to a neutral position after disengagement from the second connector member 74.

The skilled person would realise that foregoing embodiments may be modified to obtain the fluid coupler 10 of the present disclosure.

### INDUSTRIAL APPLICABILITY

This disclosure describes a fluid coupler 10 for aligning male and female fluidconnectors during reciprocal engagement. The fluid coupler 10 may align hydraulic fluidconnectors with high accuracy during engagement. The fluid coupler 10 may allow alignment of fluidconnectors in order to establish a reliable and leak free connection.

Depending on the misalignment of the fluidconnectors, the first connector member 14 carrying a fluidconnector 40 may be radially displaced in any direction and/or pivotably displaced. This may allow the fluidconnector 40 and the corresponding fluidconnector to engage smoothly so as to reduced potential wear.

During engagement and disengagement, the first connector member 14 may be separated from the hydraulic hose entry ports as the fluid circuit is depressurized.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

Where technical features mentioned in any claim are followed by references signs, the reference signs have been included for the sole purpose of increasing the intelligibility of the claims and accordingly, neither the reference signs nor their absence have any limiting effect on the technical features as described above or on the scope of any claim elements.

One skilled in the art will realise the disclosure may be embodied in other specific forms without departing from the disclosure or essential characteristics thereof The foregoing embodiments are therefore to be considered in all respects illustrative rather than limiting of the disclosure described herein. Scope of the invention is thus indicated by the appended claims, rather than the foregoing description, and all changes that come within the meaning and range of equivalence of the claims are therefore intended to be embraced therein.

1. A fluid coupler for aligned engagement of fluid connectors, comprising: a support member;
a floating first connector member housed in the support member and engageable to a second connector member; and
a piston member axially slidable in the support member.

2. The fluid coupler of claim 1 wherein the piston member is axially slidable to push the first connector member when engaged to the second connector member into abutting engagement with the support member.

3. The fluid coupler of claim 1 comprising an alignment gap between the support member and the first connector member for floating movement of the first connector member.

4. The fluid coupler of claim wherein the floating movement of the first connector member includes radial movement relative to the support member.

5. The fluid coupler of claim 3, wherein the floating movement of the first connector member includes pivotal movement relative to the support member.

6. The fluid coupler of claim 1 comprising a compressible element positioned between the support member and the first connector member to return the first connector member to a neutral position after disengagement from the second connector member.

7. The fluid coupler of claim 1, wherein the first connector member includes a fluid connector mounted in a fluid connector sleeve.

8. The fluid coupler of claim 1, wherein the piston member is pivotable in the support member.

9. The fluid coupler of claim 8 comprises further including a piston seal positioned between the piston member and the support member and configured for pivotal movement of the piston member.

10. The fluid coupler of claim 1 further including a thrust seal disposed between the piston member (16) and the first connector member.

11. The fluid coupler of claim 1, wherein the support member includes a mounting plate connected to a fluid connector cartridge.

12. A method of aligned engagement of fluid connectors, comprising:
housing a floating first connector member in a support member;
engaging the first connector member to a second connector member; and
pressurizing a fluid circuit to axially slide a piston member in the support member to press the first connector member against the support member.

13. The method of claim 12 wherein the first connector member is radially or pivotably displaceable at engagement of the first connector member to the second connector member.

14. The method of claim 12 wherein the piston member is pivotally displaceable at engagement of the first connector member to the second connector member.

15. The method of claim 12 wherein the piston member pushing the first connector member compresses a thrust seal disposed between the piston member and the first connector member.

16. The fluid coupler of claim 2, further including an alignment gap between the support member and the first connector member for floating movement of the first connector member.

17. The fluid coupler of claim 3, further including a compressible element positioned between the support member and the first connector member to return the first connector member to a neutral position after disengagement from the second connector member.

18. The fluid coupler of claim 3, wherein the first connector member includes a fluid connector mounted in a fluid connector sleeve.

19. The method of claim 13 wherein the piston member is pivotally displaceable at engagement of the first connector member to the second connector member.

20. The method of claim 13, wherein the piston member pushing the first connector member compresses a thrust seal disposed between the piston member and the first connector member.
